(19) United States
(12) Patent Application Publication
(10) Pub. No.: US 2025/0149040 A1
(43) Pub. Date: May 8, 2025

(54) METHOD AND ELECTRONIC DEVICE FOR PROVIDING UWB BASED VOICE ASSISTANCE TO USER

(71) Applicant: Samsung Electronics Co., Ltd., Suwon-si (KR)

(72) Inventors: Ankit JAIN, Delhi (IN); Siba Prasad SAMAL, Bangalore (IN); Mridul GUPTA, Indore (IN)

(21) Appl. No.: 19/018,208

(22) Filed: Jan. 13, 2025

Related U.S. Application Data
(63) Continuation of application No. PCT/KR2023/004599, filed on Apr. 5, 2023.

(30) Foreign Application Priority Data
Aug. 17, 2022 (IN) 202241046711

(51) Int. Cl. G10L 15/22; G01S 13/02; G10L 15/18

(52) U.S. Cl. CPC G10L 15/22; G01S 13/0209; G10L 15/1815

(57) ABSTRACT

A method for Ultra-Wide Band (UWB) based voice assistance to a user by an electronic device is provided. The method includes monitoring over time, by the electronic device, interactions between objects in an environment using at least one UWB sensor of the electronic device, determining, by the electronic device, at least one task and an associated objective of the at least one task corresponding to the monitored interactions, generating, by the electronic device, a semantic description of the at least one task and the associated objective in a natural language (NL) for each object, and providing, by the electronic device, the voice assistance to the user based on the semantic description in the natural language.

### CROSS-REFERENCE TO RELATED APPLICATION(S)

This application is a continuation application, claiming priority under 35 U.S.C. § 365(c), of an International application No. PCT/KR2023/004599, filed on Apr. 5, 2023, which is based on and claims the benefit of an Indian Patent Application number 202241046711, filed on Aug. 17, 2022, in the Indian Intellectual Property Office, the disclosure of which is incorporated by reference herein in its entirety.

### BACKGROUND

### 1. Field

The disclosure relates to an electronic device. More particularly, the disclosure relates to a method and the electronic device for providing Ultra-Wide Band (UWB) based voice assistance to a user.

### 2. Description of Related Art

In a multi-user/multi-object environment (e.g. home, office, etc.) a user is unable to clearly refer everyday objects such as connected objects (e.g. Internet of Things (IoT) devices) or non-connected objects (e.g. human, animal, plants, food, kitchen utensils, office utensils, etc.) and user tasks in user's voice queries which are not immediately trackable/understandable by a voice assistant. The everyday objects play an important role in the user tasks, end objectives and hence the user's voice queries, whereas existing voice assisting systems lacks storing of all such interactions making it a tedious space consuming task. Also, in the multi-user/multi-object environment multiple repetitive and unique tasks occur throughout a day. Storage of all details related to the multiple repetitive and the unique tasks is not required, whereas capturing only essential details of the tasks through understanding the user tasks and objectives is required. The existing voice assisting systems lacks the intelligence to choose the essential details of the tasks, and further, large storage space is required to capture all details related to the multiple repetitive and the unique tasks.

When the user utters ambiguous query parameters like “He” to refer to a dog or their son, the existing voice assisting systems are unable to resolve the ambiguous query parameters. Knowing who did what, avoiding redundancy, and monitoring all interactions are big tasks that no existing voice assisting systems can solve. The existing voice assisting systems need multiple IoT devices, activity tracker bands, or vision devices in an exclusive manner for tracking the interactions and understanding the object the user is referring which has management and cost problems with the user.

The tasks and the objects are not directly connected to a natural language space of the user in the existing voice assisting systems. Any querying is done on the tasks and the objects are not answerable by the existing voice assisting systems by keeping user privacy intact. Thus, it is desired to provide a useful alternative for intelligently providing voice assistance to the user.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and the electronic device for providing Ultra-Wide Band (UWB) based voice assistance to a user.

Additional aspects will be set forth in part in the description which follows and, in part, will be apparent from the description, or may be learned by practice of the presented embodiments.

In accordance with an aspect of the disclosure, a method for providing Ultra-Wide Band (UWB) based voice assistance to a user by an electronic device is provided. The method includes monitoring over time, by the electronic device, interactions between objects in an environment using at least one UWB sensor of the electronic device, determining, by the electronic device, at least one task and an associated objective of the task corresponding to the monitored interactions, generating, by the electronic device, a semantic description of the at least one task and the associated objective in a natural language for each object, and providing, by the electronic device, the voice assistance to the user based on the semantic description in the natural language.

The method further includes receiving, by the electronic device, a voice query indicative of a monitored interaction from the user, retrieving, by the electronic device, the semantic description corresponding to the at least one task and the associated objective from a semantic task and objective database based on the voice query, and generating, by the electronic device, a response to the received voice query using the retrieved semantic description.

In an embodiment, monitoring over time, by the electronic device, the interactions between the objects using the UWB sensor includes receiving, by the electronic device, UWB signals reflected from the objects, determining, by the electronic device, parameters of the objects comprising a form, a shape, a location, a movement, and an association based on the received UWB signals, and identifying, by the electronic device, the objects and the interactions between the objects based on the parameters of the objects.

In an embodiment, determining, by the electronic device, the task and the associated objective of the task corresponding to the monitored interactions, includes filtering, by the electronic device, the interactions correlated to past interaction of the user, and deriving, by the electronic device, the task and the associated objective of the task corresponding to the filtered interactions.

The method further includes storing, by the electronic device, past occurrences of the task and the associated objective in a different environment.

In an embodiment, retrieving, by the electronic device, the semantic description corresponding to the task and the associated objective from the semantic task and objective database, includes determining, by the electronic device, the objects located in proximity to the user, identifying, by the electronic device, the objects, the task and the associated objective being referred to by the user in the voice query based on the objects located in proximity to the user, correlating, by the electronic device, the identified task and the identified associated objective with the task and the associated objective stored in the semantic task and objective database, and retrieving, by the electronic device, the semantic description based on the correlation.

In accordance with an aspect of the disclosure, a method for providing Ultra-Wide Band (UWB) based voice assistance to a user by an electronic device is provided. The method includes receiving, by the electronic device, a voice query from the user, identifying, by the electronic device, at least one object in the received voice query, deriving, by the electronic device, at least one task and associated objective corresponding to the at least one identified object from the voice query, retrieving, by the electronic device, a sematic description corresponding to the at least one task and the associated objective by referring to a semantic task and objective database, and generating, by the electronic device, a response to the voice query using the retrieved semantic description.

In accordance with another aspect of the disclosure, an electronic device for providing UWB based voice assistance to the user is provided. The electronic device includes memory storing one or more computer programs, one or more processors communicatively coupled to the memory, at least one UWB sensor, and an intelligent response generator, coupled to the memory and the one or more processors, wherein the one or more computer programs include computer-executable instructions that, when executed by the one or more processors individually or collectively, cause the electronic device to monitor over time the interactions between the objects in the environment using the UWB sensor, determine the task and the associated objective of the task corresponding to the monitored interactions, generate the semantic description of the task and the associated objective in the natural language for each object, and provide the voice assistance to the user based on the semantic description in the natural language.

In accordance with another aspect of the disclosure, one or more non-transitory computer-readable storage media storing one or more computer programs including computer-executable instructions that, when executed by one or more processors of an electronic device individually or collectively, cause the electronic device to perform operations for providing Ultra-Wide Band (UWB) based voice assistance to a user are provided. The operations include monitoring over time, by the electronic device, interactions between objects in an environment using at least one UWB sensor of the electronic device, determining, by the electronic device, at least one task and an associated objective of the at least one task corresponding to the monitored interactions, generating, by the electronic device, a semantic description of the at least one task and the associated objective in a natural language for each object, and providing, by the electronic device, the voice assistance to the user based on the semantic description in the natural language.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device for providing UWB based voice assistance to a user, according to an embodiment of the disclosure;

FIG. 2 is a block diagram of an intelligent response generator for intelligently providing a response to a voice query based on past interaction with an object, according to an embodiment of the disclosure;

FIG. 3 is a flow diagram illustrating a method for providing the UWB based voice assistance to the user, according to an embodiment of the disclosure;

FIG. 4A illustrates an example scenario of learning interactions of an interested object with other objects, according to an embodiment of the disclosure;

FIG. 4B illustrates an example scenario of intelligently providing the response to the voice query based on the past interactions of the interested object with the other objects, according to an embodiment of the disclosure;

FIG. 5A illustrates an example scenario of learning behavior of the interested object with other objects, according to an embodiment of the disclosure;

FIG. 5B illustrates an example scenario of intelligently providing the response to the voice query based on the past behavior of the interested object with other objects, according to an embodiment of the disclosure;

FIG. 6A illustrates another example scenario of learning the interactions of the interested object with the other objects, according to an embodiment of the disclosure;

FIG. 6B illustrates an example scenario of intelligently providing the response to the voice query by identifying the interested object based on spatial personalization, according to an embodiment of the disclosure;

FIG. 7A illustrates another example scenario of learning the interactions of the interested object with the other objects, according to an embodiment of the disclosure; and

FIG. 7B illustrates an example scenario of intelligently providing the response to the voice query based on cross correlation between the interested object and the other objects, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is traditional in the field, embodiments may be described and illustrated in terms of blocks which carry out a described function or functions.

These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like.

The circuits constituting a block may be implemented by dedicated hardware, or by a processor (e.g., one or more programmed microprocessors and associated circuitry), or by a combination of dedicated hardware to perform some functions of the block and a processor to perform other functions of the block.

Each block of the embodiments may be physically separated into two or more interacting and discrete blocks without departing from the scope of the disclosure.

Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents and substitutes in addition to those which are particularly set out in the accompanying drawings.

The principal aspect of the embodiments herein is to provide a method and an electronic device for providing UWB based voice assistance to a user. The method allows the electronic device to understand regular objects (i.e. non-smart and non-connected objects) using UWB sensors by bringing the regular objects, interaction between the regular objects, and objective of the interactions into a Natural Language Processing (NLP) database. So the electronic device uses this database to answer voice queries related to these objects and interactions. When the user is referring to one object in the NLP database, the electronic device can easily understand the interactions related to the object in the NLP database leading to generate and provide an actual response to the user which is natural and short.

Another aspect of the embodiments herein is to resolve portions of a voice query received from the user using the objects that are near to the user, where a user personalization space depends on the objects around them when a voice query is spoken, past responses, and past queries of the user. The user can interact more naturally with the electronic device as if there is another person there. This introduction of the regular objects in the NLP space opens a load of interactions for the users and makes the query shorter for the user. The proposed method uses a voice user interface to provide insights from regular everyday activities and objects in the user's environment, allowing the user to gain access to more of the user's data. The proposed method is beneficial in a multi user environment where past interactions are needed to avoid redundancy in future, smart task completion, etc.

Accordingly, the embodiments herein provide a method for providing Ultra-Wide Band (UWB) based voice assistance to a user by an electronic device. The method includes monitoring over time, by the electronic device, interactions between objects in an environment using a UWB sensor of the electronic device. Further, the method includes determining, by the electronic device, a task and an associated objective of the task corresponding to the monitored interactions. Further, the method includes generating, by the electronic device, a semantic description of the task and the associated objective in a natural language for each object. Further, the method includes storing, by the electronic device, the semantic description in the natural language into a semantic task and objective database for providing the voice assistance to the user.

Accordingly, the embodiments herein provide the electronic device for providing UWB based voice assistance to the user. The electronic device includes an intelligent response generator, memory, a processor, and a UWB sensor, where the intelligent response generator is coupled to the memory and the processor. The intelligent response generator is configured for monitoring over time the interactions between the objects in the environment using the UWB sensor. Further, the intelligent response generator is configured for determining the task and the associated objective of the task corresponding to the monitored interactions. Further, the intelligent response generator is configured for generating the semantic description of the task and the associated objective in the natural language for each object. Further, the intelligent response generator is configured for storing the semantic description in the natural language into the semantic task and objective database for providing the voice assistance to the user.

In existing methods and systems, the user had to define all regular objects (i.e. non-smart and non-connected objects of the user) in an environment (e.g. house) for a voice assistant and add tags to these, in which owning the voice assistant will increase user's cost and their usefulness will decrease. Unlike the existing methods and systems, the electronic device understands the regular objects as important in user's NLP space by bringing the regular objects into a Natural Language Processing (NLP) space. So relevant queries can use the semantic task and objective database to answer queries related to this object and interactions. The electronic device resolves portions of a voice query received from the user using the objects that are near to the user who has spoken the voice query, where a user personalization space depends on the objects around them when query is spoken, past responses and past queries of the user. The user can interact more naturally with the electronic device as if there is another person there. This introduction of the regular objects in NLP space opens a load of interactions for the users and makes the query shorter for the user.

Consider, the user can ask “Hey, when was he given pedigree and taken for walk or not.” to the electronic device. The electronic device is able to determine that the user is asking about a dog “Bruno” since the dog is standing near to the user which is detected using the UWB sensor. Using this information the electronic device searches the semantic task and objective database for past interactions of the dog with other objects and informs the user “Bruno was given pedigree in the morning by Jarvis and taken to walk after that”.

Consider, the user can ask “Hey, I hope she didn't overexert herself today and medicated herself properly” to the electronic device. The electronic device identifies “she” as grandmother of the user. The electronic device then retrieves past smart home objectives and tasks of the grandmother's interactions with different objects in the house and tells the user that “Grandmother took 3 out of 5 of her medicines today and she exerted herself cleaning and cooking”

The proposed method is beneficial in a multi-user environment where past interactions are needed to avoid redundancy, smart task completion, etc. The proposed method uses a voice user interface to bring insights from regular everyday activities and objects in the user environment will help give access to more of the user's data to the user. When the user is referring to one object in its natural space, the electronic device can easily be understood in the NLP environment leading to more natural and short interactions.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

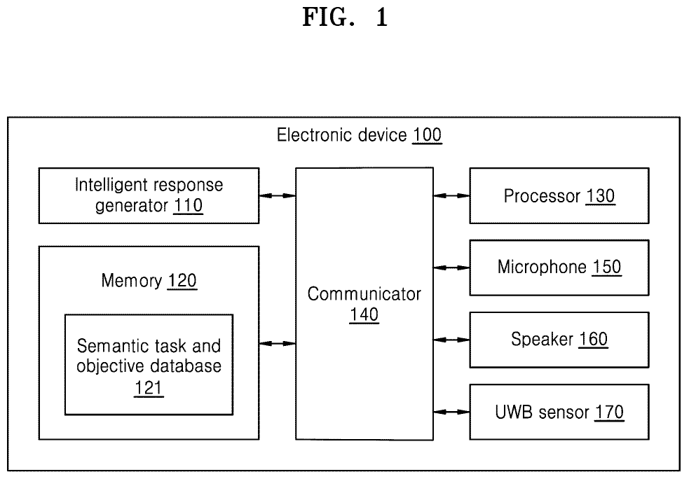

Referring now to the drawings, and more particularly to FIGS. 1 through 3, 4A, 4B, 5A, 5B, 6A, 6B, 7A, and 7B, there are shown preferred embodiments.

FIG. 1 is a block diagram of an electronic device (100) for providing UWB based voice assistance to a user, according to an embodiment of the disclosure.

Examples of the electronic device (100) include, but are not limited to a smartphone, a tablet computer, a Personal Digital Assistance (PDA), a desktop computer, an Internet of Things (IoT) device, a voice assistant, etc. In an embodiment, the electronic device (100) includes an intelligent response generator (110), memory (120), a processor (130), a communicator (140), and a microphone (150), a speaker (160), and a UWB sensor (170).

The intelligent response generator (110) is implemented by processing circuitry such as logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like.

The intelligent response generator (110) monitors over time interactions between objects include smart objects (e.g. IoT device, smartphone, laptop, etc.) and non-smart objects (e.g. home appliances, animal, plant, human, kitchen utensils, office utensils, etc.) using the UWB sensor (170) in an environment (e.g. home environment, office environment, etc.). Further, the intelligent response generator (110) determines a task and an associated objective of the task corresponding to the monitored interactions. For example, the task could be ‘putting dog food in a food bowl’, then the objective is feeding the dog. Further, the intelligent response generator (110) generates a semantic description of the task and the associated objective in a Natural Language (NL) for each set of object interactions. Further, the intelligent response generator (110) stores the semantic description in the natural language into a semantic task and objective database (121) for providing the voice assistance to the user.

In an embodiment, the intelligent response generator (110) receives a voice query indicative of the monitored interaction from the user via the microphone (150). Further, the intelligent response generator (110) retrieves the semantic description corresponding to the task and the associated objective from the semantic task and objective database (121) based on the voice query. Further, the intelligent response generator (110) generates a response to the received voice query using the retrieved semantic description. The intelligent response generator (110) provides the generated response to the user as a voice response via the speaker (160).

In an embodiment, the UWB sensor (170) receives UWB signals reflected from the objects and provides the reflected signals to the intelligent response generator (110). Further, the intelligent response generator (110) determines parameters of the objects include a form, a shape, a location, a movement, and an association based on the received UWB signals. The form of the object means a continuity of an object's surface, like an apple might be determined as a three-dimensional ellipse. The association means other objects to which one object is generally associated with or found in proximity to. For example, a dog collar might be found on a stand. Also, the dog collar might me wear by the dog. Then, the association of object “dog collar” will be with the objects “stand” and “dog”. Further, the intelligent response generator (110) identifies the objects and the interactions between the objects based on the parameters of the objects.

In an embodiment, the intelligent response generator (110) filters the interactions correlated to past interactions of the user. Further, the intelligent response generator (110) derives the task and the associated objective of the task corresponding to the filtered interactions.

In an embodiment, the intelligent response generator (110) stores past occurrences of the task and the associated objective in a different environment in the semantic task and objective database (121). In an embodiment, the intelligent response generator (110) determines the objects located in proximity to the user. In an embodiment, the intelligent response generator (110) identifies the objects, the task, and the associated objective referred to by the user in the voice query based on the objects located in proximity to the user. In an embodiment, the intelligent response generator (110) correlates the identified task and the identified associated objective with the task and the associated objective stored in the semantic task and objective database (121). In an embodiment, the intelligent response generator (110) retrieves the semantic description based on the correlation.

The memory (120) includes the semantic task and objective database (121). The memory (120) stores instructions to be executed by the processor (130). The memory (120) may include non-volatile storage elements. Examples of such non-volatile storage elements may include magnetic hard discs, optical discs, floppy discs, flash memories, or forms of electrically programmable ready only memories (EPROMs) or electrically erasable and programmable ROMs (EEPROMs). In addition, the memory (120) may, in some examples, be considered a non-transitory storage medium. The term “non-transitory” may indicate that the storage medium is not embodied in a carrier wave or a propagated signal. However, the term “non-transitory” should not be interpreted that the memory (120) is non-movable. In some examples, the memory (120) can be configured to store larger amounts of information than its storage space. In certain examples, a non-transitory storage medium may store data that can, over time, change (e.g., in Random Access Memory (RAM) or cache). The memory (120) can be an internal storage unit or it can be an external storage unit of the electronic device (100), a cloud storage, or any other type of external storage.

The processor (130) is configured to execute instructions stored in the memory (120). The processor (130) may be a general-purpose processor, such as a Central Processing Unit (CPU), an Application Processor (AP), or the like, a graphics-only processing unit such as a Graphics Processing Unit (GPU), a Visual Processing Unit (VPU) and the like. The processor (130) may include multiple cores to execute the instructions. The communicator (140) is configured for communicating internally between hardware components in the electronic device (100). Further, the communicator (140) is configured to facilitate the communication between the electronic device (100) and other devices via one or more networks (e.g. Radio technology). The communicator (140) includes an electronic circuit specific to a standard that enables wired or wireless communication.

Although FIG. 1 shows the hardware components of the electronic device (100) but it is to be understood that other embodiments are not limited thereon. In other embodiments, the electronic device (100) may include less or a greater number of components. Further, the labels or names of the components are used only for illustrative purpose and does not limit the scope of the disclosure. One or more components can be combined together to perform same or substantially similar function for providing the UWB based voice assistance to the user.

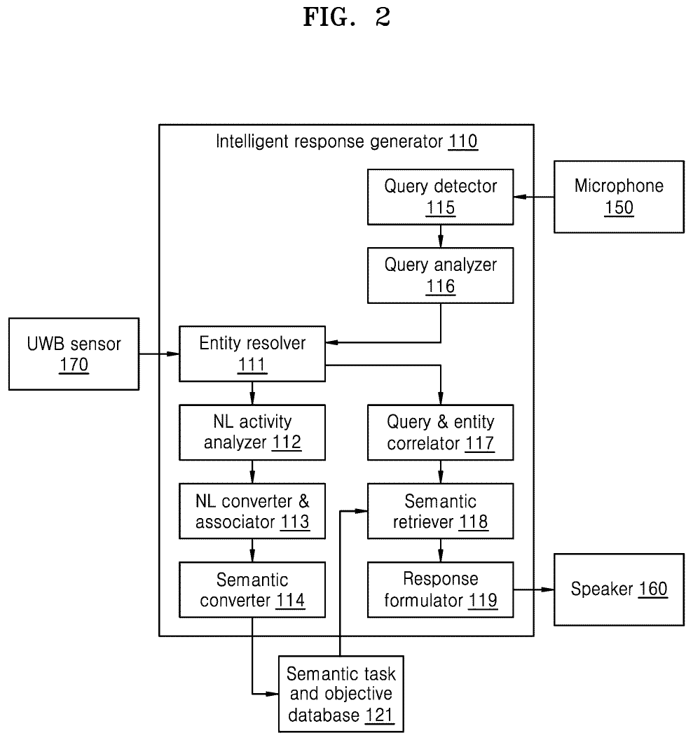

FIG. 2 is a block diagram of the intelligent response generator (110) for intelligently providing the response to the voice query based on the past interaction with the object, according to an embodiment of the disclosure.

In an embodiment, the intelligent response generator (110) includes an entity resolver (111), an NL activity analyzer (112), an NL converter & associator (113), a semantic converter (114), a query detector (115), a query analyzer (116), a query & entity correlator (117), a semantic retriever (118), and a response formulator (119). The entity resolver (111), the NL activity analyzer (112), the NL converter & associator (113), the semantic converter (114), the query detector (115), the query analyzer (116), the query & entity correlator (117), the semantic retriever (118), and the response formulator (119) are implemented by processing circuitry such as logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like.

The entity resolver (111) determines the physically referenced entities using action and words. The entity resolver (111) performs UWB based object detection, UWB based gesture recognition. The entity resolver (111) gives a score to all the recognized objects based on the query and sorts the recognized objects based on the score. The entity resolver (111) detects all the activities happening which might be a part of future answer. The entity resolver (111) triggers the remaining hardware complaints to provide response as per the proposed method. Query analyzer (116) determines the portions in spoken command that refers to UWB driven user activity or the user object. The entity resolver (111) takes the portions in the spoken command and associates the portions with the user objects. The entity resolver (111) detects the entities close to the user which are in the semantic task and objective database (121) as well, where entities are the objects and activities in the smart-home environment that is relevant to the current voice query or have future relevance.

The NL activity analyzer (112) converts retrieved entities to natural language, where multiple NL keywords are added with query parameters. The NL activity analyzer (112) filters the activities. Also, the NL activity analyzer (112) gives NL relevance, filters the entities, and passes to other hardware components. The NL activity analyzer (112) determines if the retrieved entities can be converted in user's NL usage from history of user's interactions. The NL converter & associator (113) derives the tasks. The NL converter & associator (113) gives NL word-entity relevance score and adds the tasks to the retrieved UWB entities.

The NL activity analyzer (112) takes into context of the old queries while associating the NL with the semantics. The semantic converter (114) adds the parameters for further querying, sorts the activities, and accumulates similar activities with parameters. The NL converter & associator (113) contains a keyword for sentence generation model. The NL converter & associator (113) converts the UWB entity into user's NL space and adds parameters tasks for further querying. The semantic converter (114) adds the objectives in the user's NL space. The user's NLP space is queried for relevant tasks and objectives that will be monitored in the future for query response formation. The UWB entities linked with the NL space are passed on to be converted into UWB semantics for storage and future NLP context.

The semantic converter (114) converts all this associated UWB data into UWB entity semantics which can be used in the future for generating responses in NLP, and helps to decide the best response for the received voice query.

The query detector (115) detects the voice query, and converts the voice to text. The query detector (115) and the query analyzer (116) divide the voice query into multiple groups of meaningful words, where a distinction is generated based on keywords and query understanding using NLU. The query analyzer (116) determines whether the voice query needs to process further through traditional method (e.g. Virtual assistant) or the proposed method.

The query & entity correlator (117) relates the UWB driven entities to expand the voice query by associating the UWB driven entities to possible tasks. The query & entity correlator (117) brings in other relevant entities, and determines similarity score for all the objects based on the voice query and similarity with the situation. The entity resolver (111) relates the UWB entities to the portions in the voice query. The query & entity correlator (117) correlates the possible tasks and task relations/actions, and expands the query with the possible tasks and the task relations/actions, where these tasks/objectives are retrieved from the semantic task and objective database (121) based on the query and expanded UWB query.

The semantic retriever (118) retrieves old objectives and/or tasks from the semantic task and objective database (121) with respect to the query, determines old semantic objective and task's entity similarity score.

The semantic retriever (118) finds a correlation among the query and past UWB tasks and objectives that are relevant to response formation of the query. The relevant tasks and objectives that can be used to form the response is given to the response formulator (119).

The response formulator (119) is a natural language question answering model that formulates best answer based on present scenario and old UWB semantics. The response formulator (119) gives scores to multiple answers and the best answer will be selected. The response formulator (119) outputs the most relevant response to the query based on current and previous data.

Although FIG. 2 shows the hardware components of the intelligent response generator (110) but it is to be understood that other embodiments are not limited thereon. In other embodiments, the intelligent response generator (110) may include less or a greater number of components. Further, the labels or names of the components are used only for illustrative purpose and does not limit the scope of the disclosure. One or more components can be combined together to perform same or substantially similar function for intelligently providing the response to the voice query based on the past interaction on the object.

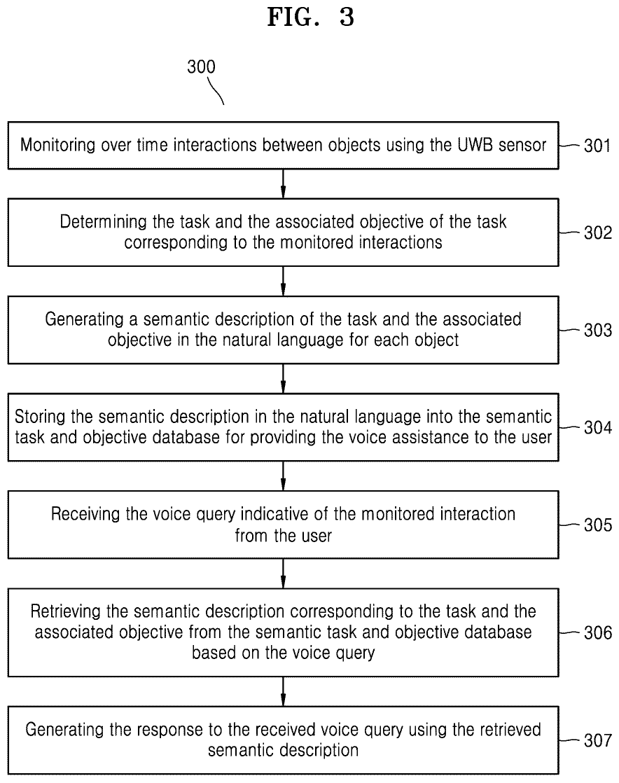

FIG. 3 is a flow diagram (300) illustrating a method for providing the UWB based voice assistance to the user, according to an embodiment of the disclosure.

In an embodiment, the method allows the intelligent response generator (110) to perform operations 301 to 307 of the flow diagram (300). At operation 301, the method includes monitoring over time the interactions between the objects using the UWB sensor (170). At operation 302, the method includes determining the task and the associated objective of the task corresponding to the monitored interactions. At operation 303, the method includes generating the semantic description of the task and the associated objective in the natural language for each object. At operation 304, the method includes storing the semantic description in the natural language into the semantic task and objective database (121) for providing the voice assistance to the user. At operation 305, the method includes receiving the voice query indicative of the monitored interaction from the user. At operation 306, the method includes retrieving the semantic description corresponding to the task and the associated objective from the semantic task and objective database (121) based on the voice query. At operation 307, the method includes generating the response to the received voice query using the retrieved semantic description.

The various actions, acts, blocks, steps, or the like in the flow diagram (300) may be performed in the order presented, in a different order, or simultaneously. Further, in some embodiments, some of the actions, acts, blocks, steps, or the like may be omitted, added, modified, skipped, or the like without departing from the scope of the disclosure.

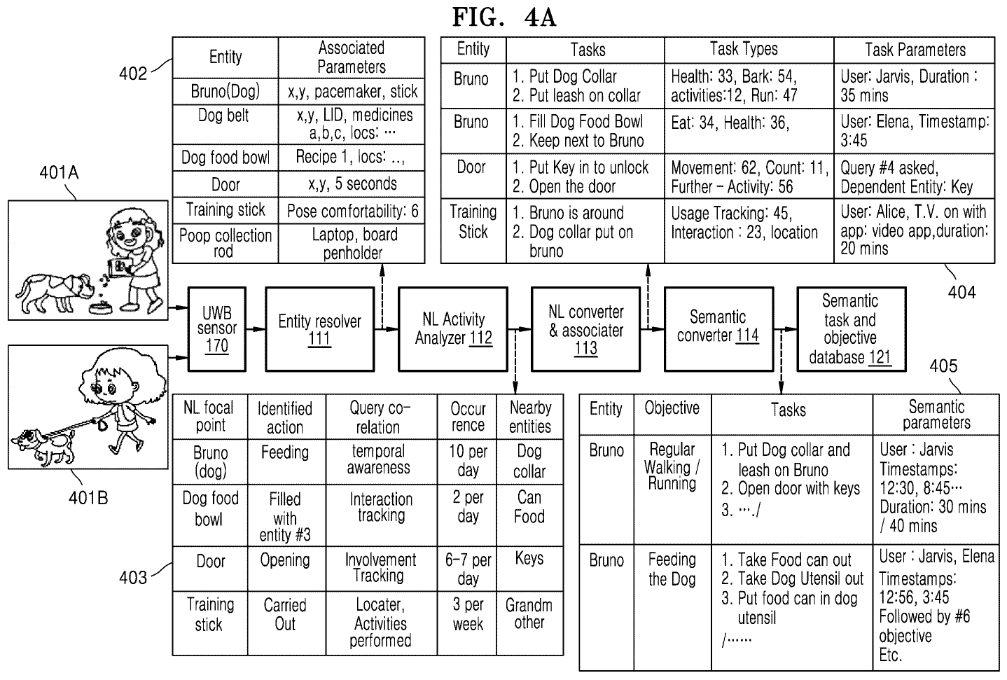

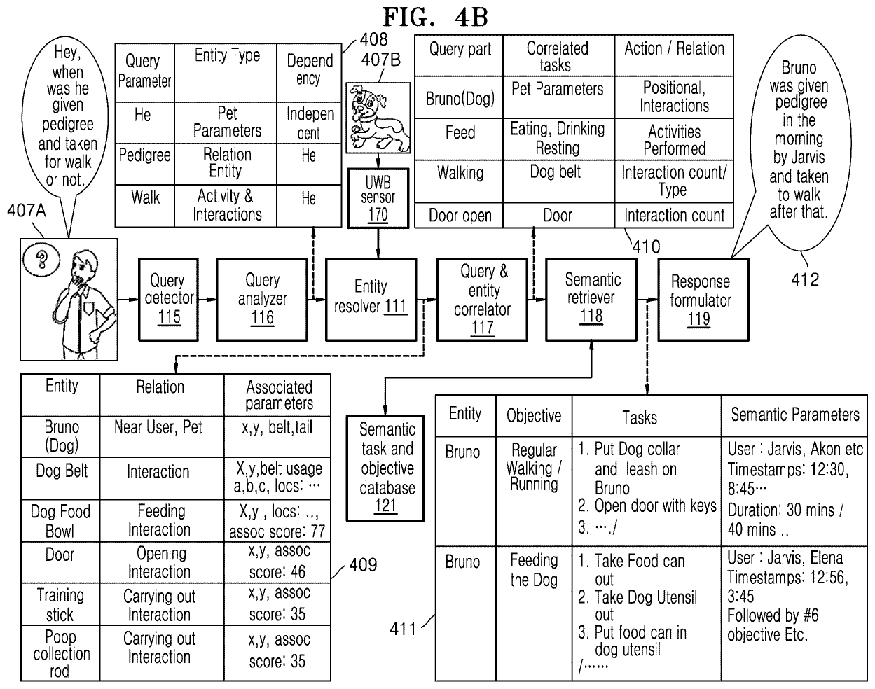

FIG. 4A illustrates an example scenario of learning interactions of an interested object with other objects, according to an embodiment of the disclosure.

Consider, the objects (also called as entities) include a dog named as Bruno, a dog belt, a dog food bowl, a door, a training stick, a poop collection rod, a dog collar, a food can, keys, grandmother, a Television (TV), a user-1 named as Jarvis, a user-2 named as Elena, and a user-3 named as Alice. The interested object in this example scenario is the dog. The electronic device (100) monitors the interactions of the dog with the other objects using the UWB sensor (170).

One interaction is, Jarvis has given food to the dog by opening the food can and serving the food to the dog food bowl as shown in 401A. Another interaction is, Jarvis has taken the dog outside the home for walking after putting the dog collar on the dog, the leash on the collar, and opening the door of the home as shown in 401B.

At 402, the entity resolver (111) determines the entities and associated parameters of the entities as given in Table 1. The associated parameters of the entities include a location (e.g. x coordinate and y coordinate in Cartesian coordinate system) of the entity, a duration of the interaction on the entity, and other objects near to the entity.

TABLE 1

| Entity | Associated parameters |
|---|---|
| Bruno (Dog) | x, y, pacemaker, stick |
| Dog belt | x, y, LID, medicines a, b, c, locs . . . |
| Dog food bowl | Recipe 1, locs . . . |
| Door | x, y, 5 seconds |
| Training stick | Pose comfortability: 6 |
| Poop collection rod | Laptop, board, penholder |

At 403, the NL activity analyzer (112) determines a NL focal point, and further determines an identified action, a query co-relation, an occurrence, and a nearby entities related to the NL focal point from the entities, the associated parameters, and the monitored interactions as given in Table 2. The NL focal point is an entity in focus relating to which all other things like past queries, nearby entities is derived. An interaction between one nearby object and the NL focal point entity is classified into the identified action, like the dog and the dog food classified together as “Feeding” action. The query co-relation defines the past query types for the given NL focal point. The nearby entities resolved by the UWB that are near/interacted with the NL focal point entity.

TABLE 2

| NL focal point | Identified action | Query co-relation | Occurrence | Nearby entities |
|---|---|---|---|---|
| Bruno (dog) | Feeding | temporal awareness | 10 per day | Dog collar |
| Dog food bowl | Filled with entity | Interaction tracking | 2 per day | Can Food |
| | #3 | | | |
| Door | Opening | Involvement | 6-7 per day | Keys |
| | | Tracking | | |
| Training stick | Carried Out | Locater, Activities | 3 per week | Grandmother |
| | | performed | | |

At 404, the NL converter & associator (113) determines the tasks done for the entity, task types, and task parameters related to the entity from the NL focal point, the identified action, the query co-relation, the occurrence, the nearby entities and the monitored interactions as given in Table 3. The task types are the types of previous task classification that the derived task might represent. i.e. the task space in which the UWB entity might belong according to the asked query. The task parameters like duration of task, who did the task etc., i.e. meta data about the task.

TABLE 3

| Entity | Tasks | Task types | Task parameters |
|---|---|---|---|
| Bruno | 1. Put Dog Collar | Health: 33, Bark: 54, | User: Jarvis, |
| | 2. Put leash on collar | activities: 12, Run: 47 | Duration: 35 mins |
| Bruno | 1. Fill Dog Food Bowl2. | Eat: 34, Health: 36, | User: Elena, |
| | Keep next to Bruno | | Timestamp: 3:45 |
| Door | 1. Put Key in to unlock2. | Movement: 62, Count: 11, | Query #4 asked, |
| | Open the door | Further - Activity: 56 | Dependent Entity: |
| | | | Key |
| Training | 1. Bruno is around | Usage Tracking: 45, | User: Alice, T.V. on |
| Stick | 2. Dog collar put on | Interaction: 23, location | with app: video app, |
| | Bruno | | duration: 20 mins |

At 405, the semantic converter (114) determines the semantic description for each entity include the objective, the tasks, and semantic parameters from the entity, and the monitored interactions as given in Table 4. The semantic parameters include who did the task, a time stamp of the task, and a duration of the task. Further, the semantic converter (114) stores the semantic description in the semantic task and objective database (121).

TABLE 4

| Entity | Objective | Tasks | Semantic parameters |
|---|---|---|---|
| Bruno | Regular | Put Dog collar and | User: Jarvis |
| | Walking/ | leash on Bruno | Timestamps: 12:30, 8:45 |
| | Running | Open door with keys | Duration: 30 mins/40 mins |
| Bruno | Feeding | Take Food can out | User; Jarvis, Elena |
| | the Dog | Take Dog Utensil out | Timestamps: 12:56, 3:45 |
| | | Put food can in dog | Followed by #6 objective |
| | | utensil | Etc. |

FIG. 4B illustrates an example scenario of intelligently providing the response to the voice query based on the past interactions of the interested object with the other objects, according to an embodiment of the disclosure.

At 407A, after storing the semantic description of the interactions by the electronic device (100) with reference to the FIG. 4A, consider later the user asks the electronic device (100) in the form of the voice query whether an entity near to the user was fed and taken out for a walk or not. Further, the query detector (115) detects the voice query and forwards the voice query to the query analyzer (116). Further, the query analyzer (116) checks whether the voice query needs to execute using a conventional method or the proposed method. At 408, upon detecting that the voice query can be executed using the proposed method, the query analyzer (116) determines query parameters, and further determines an entity type, and dependency of each query parameter as given in Table 5. The query parameter is a parameter in asked query that might have a UWB counterpart in real world and so is ambiguous right now. The entity type depending on nearby UWB entities and past, and query determining what the entity classification might be (like when UWB identifies an entity, it puts it into an entity class). The dependency according to the asked query, whether the object is standalone or is dependent on other unidentified UWB objects in the query.

TABLE 5

| Query parameter | Entity type | Dependency |
|---|---|---|
| He | Pet Parameters | Independent |
| Pedigree | Relation Entity | He |
| Walk | Activity & Interactions | He |

The entity resolver (111) determines the entities near the user using the UWB sensor (170) and further determines that the interested entity that the user is talking about is the dog (407B). At 409, the entity resolver (111) identifies the entity, and further determines a relation and the associated parameters of each entity as given in Table 6. The relation includes nearby user/pet at the identified entity, and the possible interactions on the identified entity.

TABLE 6

| Entity | Relation | Associated parameters |
|---|---|---|
| Bruno (Dog) | Near User, Pet | x, y, belt, tail |
| Dog Belt | Interaction | X, y, belt usage a, b, c, |
| | | locs |
| Dog Food Bowl | Feeding Interaction | X, y, locs |
| | | assoc score: 77 |
| Door | Opening Interaction | x, y, assoc score: 46 |
| Training stick | Carrying out Interaction | x, y, assoc score: 35 |
| Poop collection rod | Carrying out Interaction | x, y, assoc score: 35 |

At 410, the query & entity correlator (117) determines the portions in the voice query (herein called as query parts), correlated tasks, and actions/relations based on the relation and the associated parameters of each entity as given in Table 7. The actions/relations include positional, interactions, activities performed, interaction count/type, etc. The query parts are resolved ambiguous query parts to these entities. The correlated tasks are tasks generally performed on these identified query parts according to the query. The actions/relations asked when asked about the object in the query, like for the dog, generally the user asks where the dog is or what were dog's last interactions (i.e. what did the dog do).

TABLE 7

| Query part | Correlated tasks | Action/Relation |
|---|---|---|
| Bruno (Dog) | Pet Parameters | Positional, Interactions |
| Feed | Eating, Drinking Resting | Activities Performed |
| Walking | Dog belt | Interaction count/Type |
| Door open | Door | Interaction count |

At 411, the semantic retriever (118) retrieves the correlations/tasks like “dog collar put on dog” from the semantic task and objective database (121) to answer the user. The semantic retriever (118) retrieves the objectives, the tasks, and the semantic parameters of the interested object (i.e. dog) from the semantic task and objective database (121) based on the query parts, the correlated tasks, and the actions/relations as given in Table 8.

TABLE 8

| Entity | Objective | Tasks | Semantic Parameters |
|---|---|---|---|
| Bruno | Regular Walking/ | 1. Put Dog collar and leash on | User: Jarvis, Akon etc. |
| | Running | Bruno | Timestamps: 12:30, 8:45 |
| | | 2. Open door with keys | Duration: 30 mins/40 mins |
| Bruno | Feeding the Dog | 1. Take Food can out | User; Jarvis, Elena |
| | | 2. Take Dog Utensil out | Timestamps: 12:56, 3:45 |
| | | 3. Put food can in dog utensil | Followed by #6 objective |
| | | | Etc. |

At 412, the response formulator (119) creates the response informing the user that Jarvis took the dog to walk after feeding the dog.

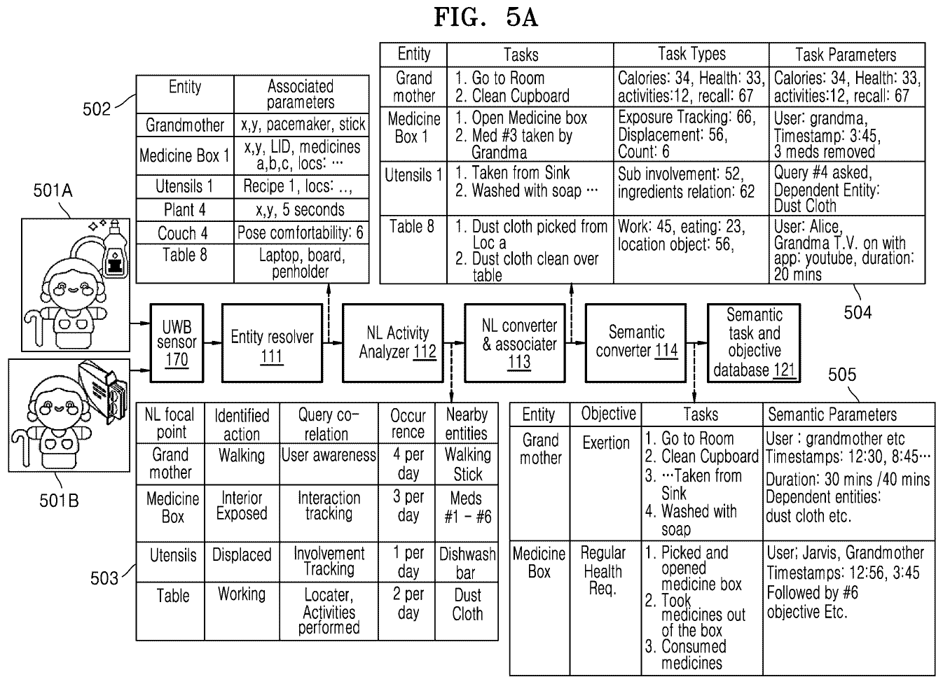

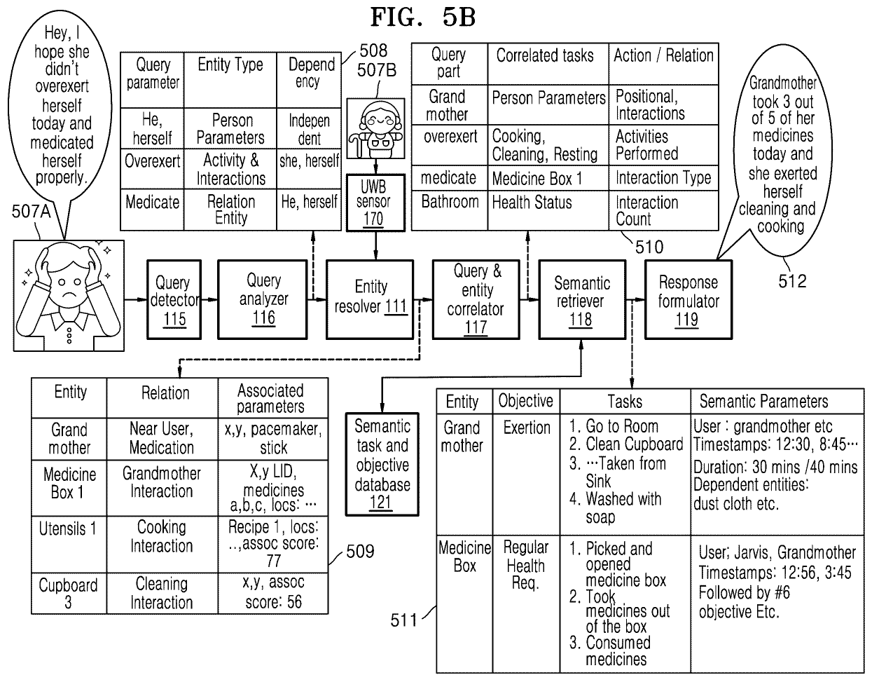

FIG. 5A illustrates an example scenario of learning behaviour of the interested object with other objects, according to an embodiment of the disclosure.

Consider, the objects (also called as entities) include the grandmother, a medicine box 1, utensils 1, plant 4, a couch 4, a table-8, a cupboard, a room, a sink, a soap, a food can, a dog utensil, the user-1 named as Jarvis, the user-3 named as Alice. The interested object in this example scenario is the grandmother. The electronic device (100) monitors the interactions of the grandmother with the other objects using the UWB sensor (170).

One interaction is, that the grandmother has exerted herself by cleaning and cooking as shown in 501A. Another interaction is, that the grandmother had medicines as shown in 501B. At 502, the entity resolver (111) determines the entities and associated parameters of the entities as given in Table 9. The associated parameters of the entities include the location (e.g. x coordinate and y coordinate in Cartesian coordinate system) of the entity, the duration of the interaction on the entity, and other objects near to the entity.

TABLE 9

| Entity | Associated parameters |
|---|---|
| Grandmother | x, y, pacemaker, stick |
| Medicine Box 1 | x, y, LID, medicines a, b, c, locs |
| Utensils 1 | Recipe 1, locs |
| Plant 4 | x, y, 5 seconds |
| Couch 4 | Pose comfortability: 6 |
| Table 8 | Laptop, board, penholder |

At 503, the NL activity analyzer (112) determines an NL focal point, and further determines the identified action, the query co-relation, the occurrence, and the nearby entities related to the NL focal point from the entities, the associated parameters, and the monitored interactions as given in Table 10.

TABLE 10

| NL focal | Identified | Query | | Nearby |
|---|---|---|---|---|
| point | action | co-relation | Occurrence | entities |
| Grandmother | Walking | User | 4 per day | Walking |
| | | awareness | | Stick |
| Medicine | Interior | Interaction | 3 per day | Meds |
| Box | Exposed | tracking | | #1-#6 |
| Utensils | Displaced | Involvement | 1 per day | Dishwash |
| | | Tracking | | bar |
| Table | Working | Locater, | 2 per week | Dust |
| | | Activities | | Cloth |
| | | performed | | |

At 504, the NL converter & associator (113) determines the tasks done by the entity, the task types, and the task parameters related to the entity from the NL focal point, the identified action, the query co-relation, the occurrence, the nearby entities and the monitored interactions as given in Table 11.

TABLE 11

| Entity | Tasks | Task types | Task parameters |
|---|---|---|---|
| Grandmother | 1. Go to Room | Calories: 34, Health: 33, | User: grandmother, |
| | 2. Clean Cupboard | activities: 12, recall: 67 | Duration: 35 mins |
| Medicine | 1. Open Medicine | Exposure Tracking: 66, | User: grandma, |
| Box 1 | box | Displacement: 56, Count: | Timestamp: 3:45, 3 |
| | 2. Med #3 taken | 6 | meds removed |
| | by Grandma | | |
| Utensils 1 | 1. Taken from | Sub involvement: 52, | Query #4 asked, |
| | Sink | ingredients relation: 62 | Dependent Entity: Dust |
| | 2. Washed with | | Cloth |
| | soap | | |
| Table 8 | 1. Dust cloth | Work: 45, eating: 23, | User: Alice, Grandma |
| | picked from Loc a | location object: 56, | T.V. on with app: video |
| | 2. Dust cloth clean | | app, duration: 20 mins |
| | over table | | |

At 505, the semantic converter (114) determines the semantic description for each entity includes the objective, the tasks, and semantic parameters from the entity, the task types, and the task parameters and the monitored interactions as given in Table 12. The semantic parameters include who did the task, the time stamp of the task, and the duration of the task, the objective, and dependent entities. Further, the semantic converter (114) stores the semantic description in the semantic task and objective database (121).

TABLE 12

| Entity | Objective | Tasks | Semantic parameters |
|---|---|---|---|
| Grandmother | Exertion | 1. Go to Room | User: grandmother etc |
| | | 2. Clean Cupboard | Timestamps: 12:30, 8:45 |
| | | 3. Taken from Sink | Duration: 30 mins/40 |
| | | 4. Washed with soap | mins |
| | | | Dependent entities: dust |
| | | | cloth etc. |
| Medicine Box | Regular Health | 1. Picked and opened | User; Jarvis, Grandmother |
| | Req. | medicine box | Timestamps: 12:56, 3:45 |
| | | 2. Took medicines out of | Followed by #6 objective |
| | | the box | Etc. |
| | | 3. Consumed medicines | |

FIG. 5B illustrates an example scenario of intelligently providing the response to the voice query based on the past behavior of the interested object with other objects, according to an embodiment of the disclosure.

At 507A, after storing the semantic description of the interactions by the electronic device (100) with reference to FIG. 5A, consider later the user asks the electronic device (100) in the form of the voice query whether someone near the user has taken medicines and has not exerted themselves. Further, the query detector (115) detects the voice query and forwards the voice query to the query analyzer (116). Further, the query analyzer (116) checks whether the voice query needs to execute using the conventional method or the proposed method. At 508, upon detecting that the voice query can be executed using the proposed method, the query analyzer (116) determines query parameters, and further determines the entity type, and the dependency of each query parameter as given in Table 13.

TABLE 13

| Query parameter | Entity type | Dependency |
|---|---|---|
| He, herself | Person Parameters | Independent |
| Overexert | Activity & Interactions | she, herself |
| Medicate | Relation Entity | He, herself |

The entity resolver (111) determines the entities near the user using the UWB sensor (170) and further determines that the interested entity that the user is talking about is the grandmother (507B). At 509, the entity resolver (111) identifies the entity, and further determines the relation and the associated parameters of each entity as given in Table 14. The relation includes nearby users at the identified entity, medication, and the possible interactions on the identified entity.

TABLE 14

| Entity | Relation | Associated parameters |
|---|---|---|
| Grandmother | Near User, Medication | x, y, pacemaker, stick |
| Medicine Box 1 | Grandmother Interaction | X, y LID, medicines a, b, c, |
| | | locs |
| Utensils 1 | Cooking Interaction | Recipe 1, locs |
| | | assoc score: 77 |
| Cupboard 3 | Cleaning Interaction | x, y, assoc score: 56 |

At 510, the query & entity correlator (117) determines the query parts, the correlated tasks, and the actions/relations based on the relation and the associated parameters of each entity as given in Table 15. The actions/relations include positional, interactions, activities performed, interaction count/type, etc.

TABLE 15

| Query part | Correlated tasks | Action/Relation |
|---|---|---|
| Grandmother | Person Parameters | Positional, Interactions |
| overexert | Cooking, Cleaning, Resting | Activities Performed |
| medicate | Medicine Box 1 | Interaction Type |
| Bathroom | Health Status | Interaction Count |

At 511, the semantic retriever (118) determines the correlations/tasks like “grandmother walking” that need to be retrieved from the semantic task and objective database (121) to answer the user. The semantic retriever (118) retrieves the objectives, the tasks, and the semantic parameters of the interested object (i.e. grandmother) from the semantic task and objective database (121) based on the query parts, the correlated tasks, and the actions/relations as given in Table 16.

TABLE 16

| Entity | Objective | Tasks | Semantic Parameters |
|---|---|---|---|
| Grandmother | Exertion | 1. Go to Room | User: grandmother etc. |
| | | 2. Clean Cupboard | Timestamps: 12:30, 8:45 |
| | | 3. Taken from Sink | Duration: 30 mins/40 |
| | | 4. Washed with soap | mins |
| | | | Dependent entities: dust |
| | | | cloth etc. |
| Medicine Box | Regular Health | 1. Picked and opened | User; Jarvis, Grandmother |
| | Req. | medicine box | Timestamps: 12:56, 3:45 |
| | | 2. Took medicines out of | Followed by #6 objective |
| | | the box | Etc. |
| | | 3. Consumed medicines | |

At 512, the response formulator (119) creates the response informing the user that about various activities the grandmother did which might have resulted in over exertion and that the grandmother interacted with the medicine box.

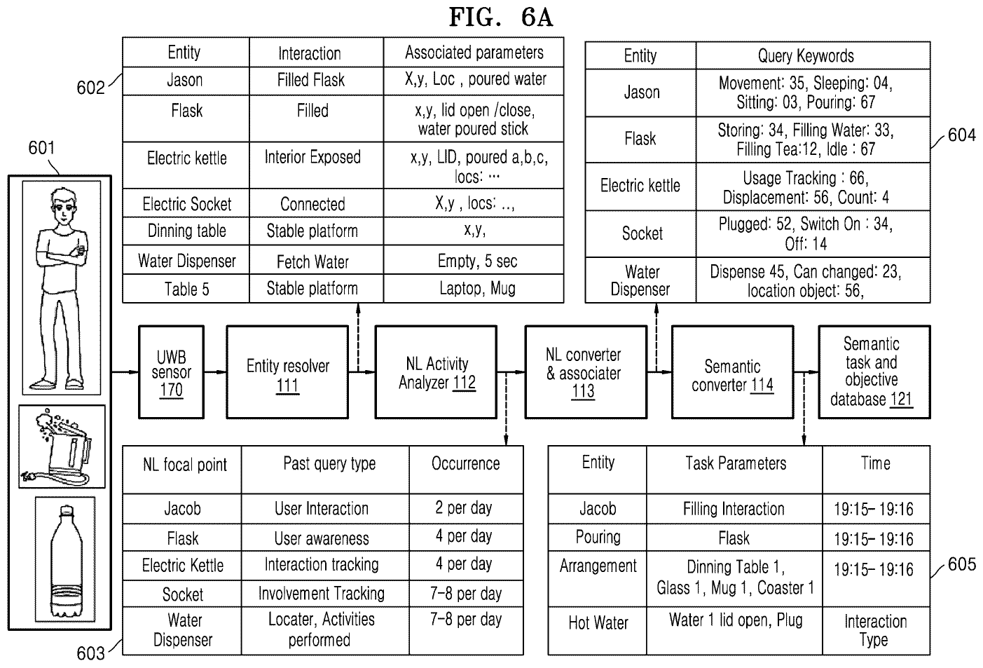

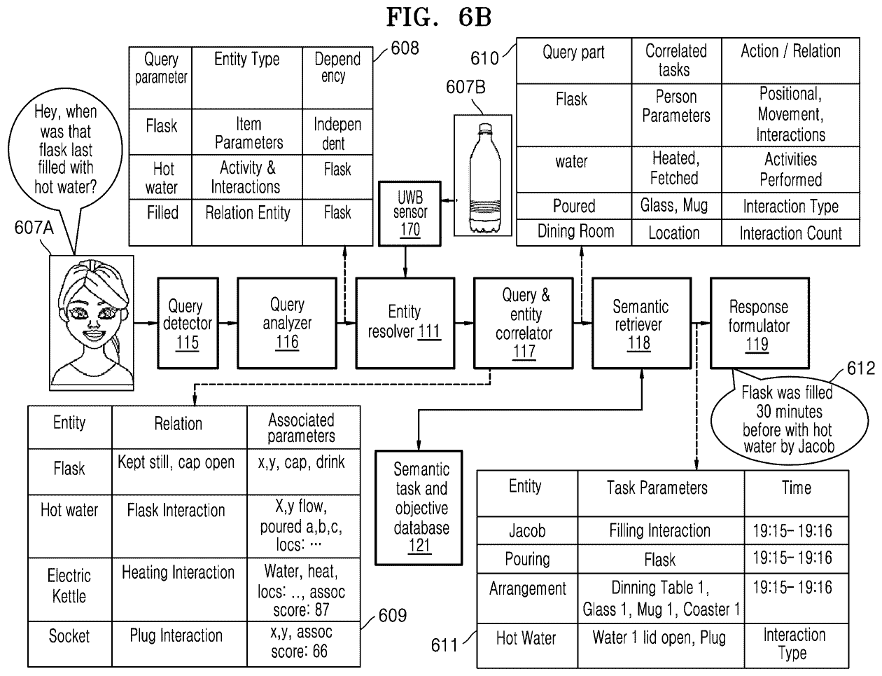

FIG. 6A illustrates another example scenario of learning the interactions of the interested object with the other objects, according to an embodiment of the disclosure.

Consider, the objects (also called as entities) include an electric kettle, an electric socket, a dining table, a water dispenser, a table-5, a flask, a glass, a mug, a coaster, and the user-4 named Jacob. The interested object in this example scenario is the flask. The electronic device (100) monitors the interactions of the flask with the other objects using the UWB sensor (170).

One interaction is, Jacob prepared hot water using the electric kettle and poured the hot water to the flask as shown in 601. At 602, the entity resolver (111) determines the entities, the interaction between the entities and the associated parameters of the entities as given in Table 17. The associated parameters of the entities include the location (e.g. x coordinate and y coordinate in Cartesian coordinate system) of the entity, the duration of the interaction on the entity, and other objects near to the entity.

TABLE 17

| Entity | Interaction | Associated parameters |
|---|---|---|
| Jacob | Filled Flask | X, y, Loc, poured water |
| Flask | Filled | x, y, lid open/close, water poured |
| | | stick |
| Electric kettle | Interior Exposed | x, y, LID, poured |
| | | a, b, c, loc |
| Electric Socket | Connected | X, y, locs: . . . , |
| Dining table | Stable platform | x, y |
| Water Dispenser | Fetch Water | Empty, 5 sec |
| Table 5 | Stable platform | Laptop, Mug |

At 603, the NL activity analyzer (112) determines the NL focal point, and further determines a past query type, and the occurrence as given in Table 18. The past queries type were about the entity.

TABLE 18

| NL focus point | Past query type | Occurrence |
|---|---|---|
| Jacob | User Interaction | 2 per Day |
| Flask | User awareness | 4 per day |
| Electric Kettle | Interaction tracking | 4 per day |
| Socket | Involvement Tracking | 7-8 per day |
| Water Dispenser | Locater, Activities performed | 7-8 per day |

At 604, the NL converter & associator (113) determines the query keywords for the entity from the NL focal point, the past query type, and the occurrence as given in Table 19. The query keywords from past queries that was asked about the given entity.

TABLE 19

| Entity | Query Keywords |
|---|---|
| Jacob | Movement: 35, Sleeping: 04, Sitting: 03, Pouring: 67 |
| Flask | Storing: 34, Filling Water: 33, Filling Tea: 12, Idle: 67 |
| Electric Kettle | Usage Tracking: 66, Displacement: 56, Count: 4 |
| Socket | Plugged: 52, Switch On: 34, Off: 14 |
| Water Dispenser | Dispense 45, Can changed: 23, location object: 56, |

At 605, the semantic converter (114) determines the semantic description for each entity includes the objective, the tasks, and the task parameters from the query keywords of each entity and the monitored interactions. The task parameters include the user done the task, the time stamp of the task, and the interaction type. Further, the semantic converter (114) stores the semantic description in the semantic task and objective database (121).

FIG. 6B illustrates an example scenario of intelligently providing the response to the voice query by identifying the interested object based on spatial personalization, according to an embodiment of the disclosure.

At 607A, after storing the semantic description of the interactions by the electronic device (100) with reference to FIG. 6A, consider later the user asks the electronic device (100) in the form of the voice query that when was the flask last filled with hot water. Further, the query detector (115) detects the voice query and forwards the voice query to the query analyzer (116). Further, the query analyzer (116) checks whether the voice query needs to execute using the conventional method or the proposed method. At 608, upon detecting that the voice query can be executed using the proposed method, the query analyzer (116) determines the query parameters, and further determines the entity type, and the dependency of each query parameter as given in Table 20.

TABLE 20

| Query parameter | Entity type | Dependency |
|---|---|---|
| Flask | Item Parameters | Independent |
| Hot water | Activity & Interactions | Flask |
| Filled | Relation Entity | Flask |

The entity resolver (111) determines the entities near the user using the UWB sensor (170) and further determines that the interested entity which the user is talking about is the flask (607B). At 609, the entity resolver (111) identifies the entity, and further determines the relation and the associated parameters of each entity as given in Table 21. The relation includes nearby user at the identified entity, functional state of the identified entity, and the possible interactions on the identified entity.

TABLE 21

| Entity | Relation | Associated parameters |
|---|---|---|
| Flask | Kept still, cap open | x, y, cap, drink |
| Hot water | Flask Interaction | X, y flow, poured a, b, c, locs |
| Electric Kettle | Heating Interaction | Water, heat, locs assoc score: 87 |
| Socket | Plug Interaction | x, y, assoc score: 66 |

At 610, the query & entity correlator (117) determines the query parts, the correlated tasks, and the actions/relations based on the relation and the associated parameters of each entity as given in Table 22. The actions/relations include positional, interactions, activities performed, interaction count/type, etc.

TABLE 22

| Query part | Correlated tasks | Action/Relation |
|---|---|---|
| Flask | Person Parameters | Positional, Movement, Interactions |
| Water | Heated, Fetched | Activities Performed |
| Poured | Glass, Mug | Interaction Type |
| Dining Room | Location | Interaction Count |

At 611, the semantic retriever (118) determines the correlations/tasks like “hot water dispersion” that needs to be retrieved from the semantic task and objective database (121) to answer the user. The semantic retriever (118) retrieves the objectives, the tasks, and the task parameters of the interested object (i.e. flask) from the semantic task and objective database (121) based on the query parts, the correlated tasks, and the actions/relations.

At 612, the response formulator (119) creates the response informing the user about the time and the person who was last filled the flask with the hot water.

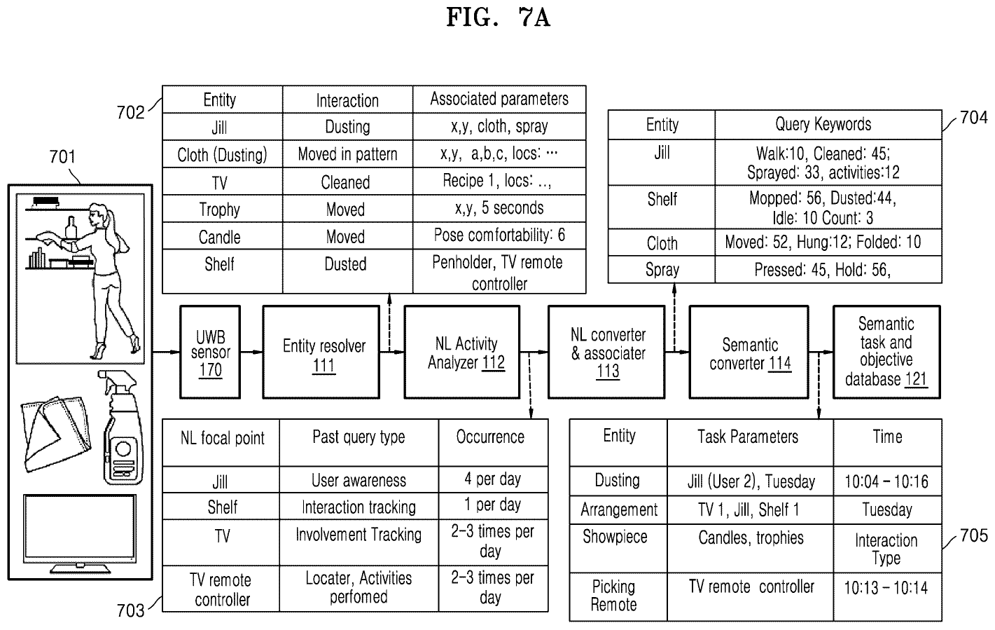

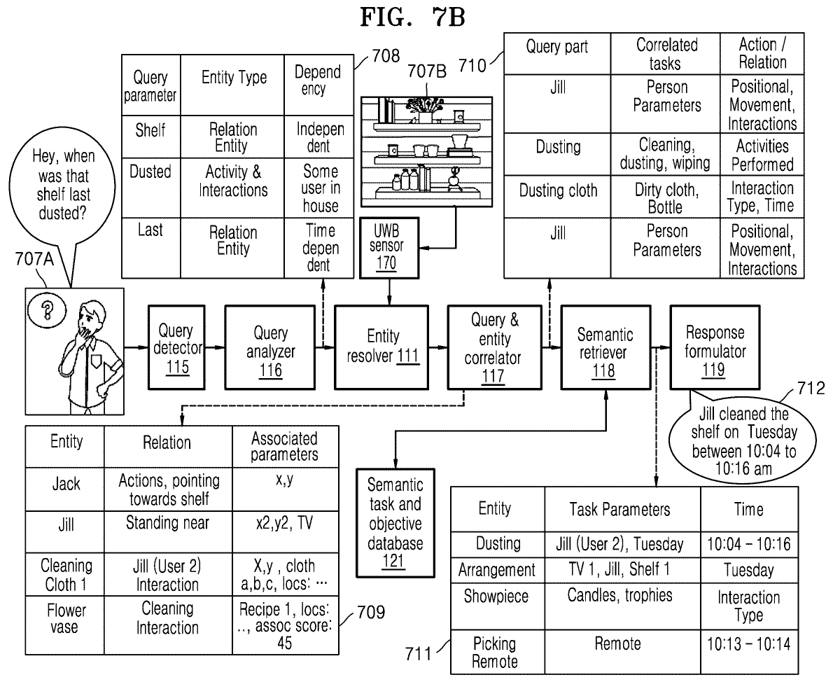

FIG. 7A illustrates another example scenario of learning the interactions of the interested object with the other objects, according to an embodiment of the disclosure.

Consider, the objects (also called as entities) include a shelf, a dusting cloth, flower vase, a TV, a trophy, a candle, a TV remote controller, a spray, and a user-5 named Jill, a user-6 named Jack. The interested object in this example scenario is the shelf. The electronic device (100) monitors the interactions of the shelf with the other objects using the UWB sensor (170).

One interaction is, Jill dusted the shelf and the TV using the dusting cloth and the spray as shown in 701. At 702, the entity resolver (111) determines the entities, the interaction between the entities and the associated parameters of the entities as given in Table 23. The associated parameters of the entities include the location (e.g. x coordinate and y coordinate in Cartesian coordinate system) of the entity, the duration of the interaction on the entity, and other objects near to the entity.

TABLE 23

| Entity | Interaction | Associated parameters |
|---|---|---|
| Jill | Dusting | x, y, cloth, spray |
| Cloth (Dusting) | Moved in pattern | x, y, a, b, c, locs |
| TV | Cleaned | Recipe 1, locs |
| Trophy | moved | x, y, 5 seconds |
| Candle | Moved | Pose comfortability: 6 |
| Shelf | Dusted | Penholder, TV remote controller |

At 703, the NL activity analyzer (112) determines the NL focal point, and further determines a past query type, and the occurrence as given in Table 24.

TABLE 24

| NL focus point | Past query type | Occurrence |
|---|---|---|
| Jill | Dusting | x, y, cloth, spray |
| Cloth (Dusting) | Moved in pattern | x, y, a, b, c, locs |
| TV | Cleaned | Recipe 1, locs |
| Trophy | moved | x, y, 5 seconds |

At 704, the NL converter & associator (113) determines the query keywords for the entity from the NL focal point, the past query type, and the occurrence as given in Table 25.

TABLE 25

| Entity | Query Keywords |
|---|---|
| Jill | Walk: 10, Cleaned: 45; Sprayed: 33, activities: 12 |
| Shelf | Mopped: 56, Dusted: 44, Idle: 10 Count: 3 |
| Cloth | Moved: 52, Hung: 12; Folded: 10 |
| Spray | Pressed: 45, Hold: 56 |

At 705, the semantic converter (114) determines the semantic description for each entity includes the objective, the tasks, and the task parameters from the query keywords of each entity and the monitored interactions. The task parameters include the user done the task, the time stamp of the task, and the interaction type. Further, the semantic converter (114) stores the semantic description in the semantic task and objective database (121).

FIG. 7B illustrates an example scenario of intelligently providing the response to the voice query based on cross correlation between the interested object and the other objects, according to an embodiment of the disclosure.

At 707A, after storing the semantic description of the interactions by the electronic device (100) with reference to FIG. 7A, consider later the user asks the electronic device (100) in the form of the voice query that when was the flask last dusted. Further, the query detector (115) detects the voice query and forwards the voice query to the query analyzer (116). Further, the query analyzer (116) checks whether the voice query needs to execute using the conventional method or the proposed method. At 708, upon detecting that the voice query can be executed using the proposed method, the query analyzer (116) determines the query parameters, and further determines the entity type, and the dependency of each query parameter as given in Table 26.

TABLE 26

| Query parameter | Entity type | Dependency |
|---|---|---|
| Shelf | Relation Entity | Independent |
| Dusted | Activity & Interactions | Some user in house |
| Last | Relation Entity | Time dependent |

The entity resolver (111) determines the entities near the user using the UWB sensor (170) and further determines that the interested entity which the user is talking about is the shelf (707B). At 709, the entity resolver (111) identifies the entity, and further determines the relation and the associated parameters of each entity as given in Table 27. The relation includes the nearby user at the identified entity, the functional state of the identified entity, and the possible interactions on the identified entity.

TABLE 27

| Entity | Relation | Associated parameters |
|---|---|---|
| Jack | Actions, pointing towards | x, y |
| | shelf | |
| Jill | Standing near | x2, y2, TV |
| Cleaning Cloth 1 | Jill (User 2) Interaction | X, y, cloth a, b, c, locs |
| Flower vase | Cleaning Interaction | Recipe 1, locs |
| | | assoc score: 45 |

At 710, the query & entity correlator (117) determines the query parts, the correlated tasks, and the actions/relations based on the relation and the associated parameters of each entity as given in Table 28. The actions/relations include positional, interactions, activities performed, interaction count/type, etc.

TABLE 28

| Query part | Correlated tasks | Action/Relation |
|---|---|---|
| Jill | Person Parameters | Positional, Movement |
| | | Interactions |
| Dusting | Cleaning, dusting, wiping | Activities Performed |
| Dusting cloth | Dirty cloth, Bottle | Interaction Type, Time |
| Jill | Person Parameters | Positional, Movement |
| | | Interactions |

At 711, the semantic retriever (118) determines the correlations/tasks like “dust cloth pickup” that needs to be retrieved from the semantic task and objective database (121) to answer the user. The semantic retriever (118) retrieves the objectives, the tasks, and the task parameters of the interested object (i.e. shelf) from the semantic task and objective database (121) based on the query parts, the correlated tasks, and the actions/relations.

At 712, the response formulator (119) creates the response informing the user about the time the shelf was last dusted by Jill.

The embodiments disclosed herein can be implemented using at least one hardware device and performing network management functions to control the elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for providing Ultra-Wide Band (UWB) based voice assistance to a user by an electronic device, comprising:
monitoring over time, by the electronic device, interactions between objects in an environment using at least one UWB sensor of the electronic device;
determining, by the electronic device, at least one task and an associated objective of the at least one task corresponding to the monitored interactions;
generating, by the electronic device, a semantic description of the at least one task and the associated objective in a natural language for each object; and
providing, by the electronic device, the voice assistance to the user based on the semantic description in the natural language.

2. The method as claimed in claim 1, wherein the method further comprises:
receiving, by the electronic device, a voice query indicative of at least one monitored interaction from the user;
retrieving, by the electronic device, the semantic description corresponding to the at least one task and the associated objective from a semantic task and objective database based on the voice query; and
generating, by the electronic device, a response to the received voice query using the retrieved semantic description.

3. The method as claimed in claim 1, wherein the monitoring over time, by the electronic device, of the interactions between the objects using the at least one UWB sensor, comprises:
receiving, by the electronic device, UWB signals reflected from the objects;
determining, by the electronic device, at least one parameter of the objects comprising a form, a shape, a location, a movement, and an association based on the received UWB signals; and
identifying, by the electronic device, the objects and the interactions between the objects based on the at least one parameter of the objects.

4. The method as claimed in claim 1, wherein determining, by the electronic device, the at least one task and the associated objective of the at least one task corresponding to the monitored interactions, comprises:
filtering, by the electronic device, the interactions correlated to past interaction of the user; and
deriving, by the electronic device, the at least one task and the associated objective of the at least one task corresponding to the filtered interactions.

5. The method as claimed in claim 1, wherein the method, comprises:
storing, by the electronic device, at least one of past occurrences of the at least one task and the associated objective in a different environment.

6. The method as claimed in claim 2, wherein retrieving, by the electronic device (100), the semantic description corresponding to the at least one task and the associated objective from the semantic task and objective database, comprises:
determining, by the electronic device, the objects located in proximity to the user;
identifying, by the electronic device, the objects, the at least one task, and the associated objective being referred to by the user in the voice query based on the objects located in proximity to the user;
correlating, by the electronic device, the at least one identified task and the identified associated objective with the at least one task and the associated objective stored in the semantic task and objective database; and
retrieving, by the electronic device, the semantic description based on the correlation.

7. The method as claimed in claim 1, wherein the objects include at least one of users, devices, pets, plants, or utensils, whereas the environment includes at least one of home, office or any similar enclosed building.

8. A method for providing Ultra-Wide Band (UWB) based voice assistance to a user by an electronic device, comprising:
receiving, by the electronic device, a voice query from the user;
identifying, by the electronic device, at least one object in the received voice query;
deriving, by the electronic device, at least one task and associated objective corresponding to the at least one identified object from the voice query;
retrieving, by the electronic device, a sematic description corresponding to the at least one task and the associated objective by referring to a semantic task and objective database; and
generating, by the electronic device, a response to the voice query using the retrieved semantic description.

9. The method as claimed in claim 8, further comprising:
monitoring over time, by the electronic device, interactions between objects in an environment using at least one UWB sensor.

10. The method as claimed in claim 9, wherein the monitoring over time, by the electronic device, of the interactions between the objects using the at least one UWB sensor, comprises:
receiving, by the electronic device, UWB signals reflected from the objects;
determining, by the electronic device, at least one parameter of the objects comprising a form, a shape, a location, a movement, and an association based on the received UWB signals; and
identifying, by the electronic device, the objects and the interactions between the objects based on the at least one parameter of the objects.

11. The method as claimed in claim 9, wherein the deriving, by the electronic device, of the at least one task and the associated objective of the at least one task corresponding to the monitored interactions comprises:
filtering, by the electronic device, the interactions correlated to past interaction of the user.

12. An electronic device for providing Ultra-Wide Band (UWB) based voice assistance to a user, comprising:
memory storing one or more computer programs;
one or more processors communicatively coupled to the memory;
at least one UWB sensor; and
an intelligent response generator, coupled to the memory and the one or more processors,
wherein the one or more computer programs include computer-executable instructions that, when executed by the one or more processors individually or collectively, cause the electronic device to:
monitor, over time, interactions between objects in an environment using the at least one UWB sensor,
determine at least one task and an associated objective of the at least one task corresponding to the monitored interactions,
generate a semantic description of the at least one task and the associated objective in a natural language for each object, and
provide the voice assistance to the user based on the semantic description in the natural language.

13. The electronic device as claimed in claim 12, wherein the one or more computer programs further include computer-executable instructions that, when executed by the one or more processors individually or collectively, cause the intelligent response generator of the electronic device to:
receive a voice query indicative of at least one monitored interaction from the user;
retrieve the semantic description corresponding to the at least one task and the associated objective from a semantic task and objective database based on the voice query; and
generate a response to the received voice query using the retrieved semantic description.

14. The electronic device as claimed in claim 13, wherein the intelligent response generator includes an entity resolver configured to perform UWB based object detection using the UWB sensor.

15. The electronic device as claimed in claim 14, wherein the entity resolver is configured to give a score to detected objects based on the query.

16. The electronic device as claimed in claim 12, wherein, to monitor over time of the interactions between the objects using the at least one UWB sensor, one or more computer programs further include computer-executable instructions that, when executed by the one or more processors individually or collectively, cause the electronic device to:
receive UWB signals reflected from the objects;
determine at least one parameter of the objects comprising a form, a shape, a location, a movement, and an association based on the received UWB signals; and
identify the objects and the interactions between the objects based on the at least one parameter of the objects.

17. The electronic device as claimed in claim 12, wherein, to determine the at least one task and the associated objective of the at least one task corresponding to the monitored interactions, one or more computer programs further include computer-executable instructions that, when executed by the one or more processors individually or collectively, cause the electronic device to:
filter the interactions correlated to past interaction of the user; and
derive the at least one task and the associated objective of the at least one task corresponding to the filtered interactions.

18. The electronic device as claimed in claim 12, wherein the one or more computer programs further include computer-executable instructions that, when executed by the one or more processors individually or collectively, cause the intelligent response generator of the electronic device to:
store at least one of past occurrences of the at least one task and the associated objective in a different environment.

19. The electronic device as claimed in claim 13, wherein, to retrieve the semantic description corresponding to the at least one task and the associated objective from the semantic task and objective database, one or more computer programs further include computer-executable instructions that, when executed by the one or more processors individually or collectively, cause the electronic device to:
determine the objects located in proximity to the user;
identify the objects, the at least one task, and the associated objective being referred to by the user in the voice query based on the objects located in proximity to the user;
correlate the at least one identified task and the identified associated objective with the at least one task and the associated objective stored in the semantic task and objective database; and
retrieve the semantic description based on the correlation.

20. The electronic device as claimed in claim 12, wherein the objects include at least one of users, devices, pets, plants, or utensils, whereas the environment includes at least one of home, office or any similar enclosed building.
